(19) United States
(12) Patent Application Publication
(10) Pub. No.: US 2009/0095352 A1
(43) Pub. Date: Apr. 16, 2009

(54) LARGE SCALE PULSED ENERGY WATER TREATMENT SYSTEM

(75) Inventor: Robert Kovalcik, Longwood, FL (US)

Correspondence Address: MICHAUD-DUFFY GROUP LLP, 306 INDUSTRIAL PARK ROAD, SUITE 206, MIDDLETOWN, CT, 06457, US

(73) Assignee: Clearwater Systems Corporation, Essex, CT (US)

(21) Appl. No.: 12/246,851

(22) Filed: Oct. 7, 2008

Related U.S. Application Data
(60) Provisional application No. 60/979,238, filed on Oct. 11, 2007.

(51) Int. Cl. F17D 1/08; F16L 41/00

(52) U.S. Cl. 137/13; 137/561 A

(57) ABSTRACT

A flow of fluid such as water is subjected to pulsed energy by dividing the flow into a plurality of divided flows; subjecting each divided flow to pulses of electromagnetic energy; and coalescing the plurality of divided flows into an output flow. A treatment apparatus includes a flow divider apparatus that has a inflow coupler and a plurality of conduits in fluid communication with the inflow coupler. Each conduit has a coil assembly thereon. The apparatus has a outflow coupler that is in fluid communication with each conduit. Coil assemblies on adjacent conduits may be staggered between the inflow coupler and the outflow coupler. The apparatus may include a control circuit for each coil assembly, for generating ringing pulses in the coil assembly.

### CROSS-REFERENCE TO RELATED APPLICATIONS

This application claims the benefit of U.S. provisional application No. 60/979,238, filed Oct. 11, 2007, which is hereby incorporated herein by reference in its entirety.

### FIELD OF THE INVENTION

This invention relates to pulsed energy water treatment, and in particular to a system and method for pulsed energy water treatment of large flow rate applications.

### BACKGROUND

Pulsed energy water treatment systems face limitations regarding the flow rate that can be effectively treated in a system having a given pipe size, standard coil configuration and power supply. Example systems of this kind are commercially available under the trademark Dolphin.

Various different devices and methods are known for treating liquids with electromagnetic flux for the purpose of reducing the scaling propensity of the liquid, for reducing the number of living microorganisms contained in the liquid or for other purposes. For example, an apparatus for treating flowing liquid with electromagnetic flux is disclosed in U.S. Pat. No. 6,063,267 assigned to Clearwater Systems, LLC, the disclosure of which is herein incorporated by reference.

Some of these prior devices have used either stationary or movable permanent magnets for producing a magnetic flux. Other devices have used electrical coils arranged in various different ways with respect to pipes conducting the liquid. These devices create an electromagnetic flux used as the liquid treatment factor by energizing the coils with either a direct or alternating source. In the case of devices using electromagnetic flux, it is known from U.S. Pat. No. 5,702,600 to provide an apparatus including a plurality of electrical coils surrounding different separate longitudinal sections of a liquid conducting pipe, with two of the coils being wound on top of one another, a diode being so connected in circuit with the coils and with the power source that current from the power source is conducted through the coils only during alternate half-cycles of one voltage polarity, with some current of a ringing nature apparently flowing through each coil following the end of each half-cycle of diode conduction. Devices of this type produce two types of electromagnetic fields. During the portion of the AC power cycle in which the diode conducts, the coils produce a low frequency (commonly 50 or 60 Hz) electromagnetic field. The generation of this field requires that substantial current flow through the diode and the coils. During the portion of the AC power cycle in which the diode does not conduct, the coils, in conjunction with stray or discrete capacitance in the circuit, generates a high frequency ringing electromagnetic field. Both types of electromagnetic fields generated are thought to be significant in the treatment of flowing liquids. However, the ringing current, and the electromagnetic flux produced by devices such as that described in the '600 patent appear to be weak and of very short duration so as to be of small effectiveness.

Prior systems for treating flowing liquids with a ringing magnetic pulse used a diode switch to interrupt the coil current when the current reversed polarity. For example, a prior analog control system produced a relatively small “ringing” pulse on the coil voltage when the current was blocked by the diode because there was still voltage remaining on the coil capacitance. The analog control system was modified to generate a much larger “ringing” voltage of up to ten times that of the previously-mentioned analog control system. This design used in place of the diode, a switch comprising up to ten parallel-connected 450 volt MOSFETs. This switch interrupted the current flow before the coil current reached zero, leaving stored magnetic energy in the coil which powered the larger “ringing” pulse. With this approach, a switch is needed that can be electronically “turned off”, and such switches tend to be low current devices with relatively high “ON state” resistance. As a result, ten switches in parallel are needed to handle the full coil current.

Digital control systems have been developed in order to improve stability of operation relative to that of the above-mentioned analog control systems. However, there is still a need to lower the complexity and cost of such digital control systems. Irrespective of whether digital or analog control is used, devices of this type produce ringing pulses which are believed to provide better fluid treatment, however, the circuitry required to produce both the low frequency and ringing electromagnetic fields in these devices is sufficiently complex and inefficient so as to be considered less than desirable.

Large scale water flows, such as cooling tower water flows, often exceed the capacity of conventional pulsed energy water treatment systems. Still, if such systems could be adapted for use with large scale water flows, they could impart the benefits provided to smaller scale flows, i.e., mineral scale prevention, bacteria control, and corrosion inhibition. While the Dolphin™ product line is typically used for HVAC cooling towers typically found on office buildings and other commercial facilities, large flow rate applications are usually found in power generation facilities, central utility plants (steam and chilled water facilities), co-generation facilities, and industrial plant such as the Chemical Process Industry, Ethanol Production, BioFuel Plants, Refineries, Pulp and Paper Plants, and the like.

### SUMMARY OF THE INVENTION

The present invention resides in one aspect in a method for subjecting a flow of fluid to pulsed energy. The method comprises dividing the fluid into a plurality of flows; subjecting each flow to pulses of electromagnetic energy; and coalescing the plurality of flows into a single flow.

The present invention resides in another aspect in a fluid treatment flow divider apparatus that comprises an inflow coupler. There is a plurality of conduits, each having an inlet end and an outlet end, and each inlet end is open to, and in fluid communication with, the inflow coupler. Each conduit has a coil assembly thereon. The apparatus also includes a outflow coupler that is open to, and in fluid communication with, the outlet end of each conduit. In one specific embodiment, the coil assemblies on adjacent conduits are staggered from each other between the inflow coupler and the outflow coupler. The apparatus may include a control circuit for each coil, for generating ringing pulses in the coil assembly.

### BRIEF DESCRIPTION OF THE DRAWINGS

FIG. 1 is a schematic circuit diagram of an apparatus for generating a ringing magnetic pulse for treating flowing liquid in accordance with the invention;

FIG. 2 is an oscilloscope trace showing a single large ringing pulse according to the invention;

FIG. 3 is an oscilloscope trace showing a “natural” ringing pulse followed by more than one large ringing pulse according to the invention;

FIG. 4 is an oscilloscope trace showing a series of six full large ringing pulses according to the invention;

FIG. 5 is an oscilloscope trace showing a series of ringing pulses initiated without letting prior pulses substantially decay, according to one embodiment of the invention;

FIG. 6 is a schematic, partially broken-away perspective view of a flow divider apparatus as described herein;

FIG. 7 is a schematic, partially broken-away elevation view of the flow divider apparatus of FIG. 6 together with a control unit and an optional pump.

FIG. 8 is a schematic cross-sectional view of a conduit with a sample coil assembly thereon;

FIG. 9 is a wiring diagram for the coil assembly of FIG. 8; and

FIG. 10 is a schematic view of an alternative embodiment of a flow divider apparatus.

### DETAILED DESCRIPTION OF THE INVENTION

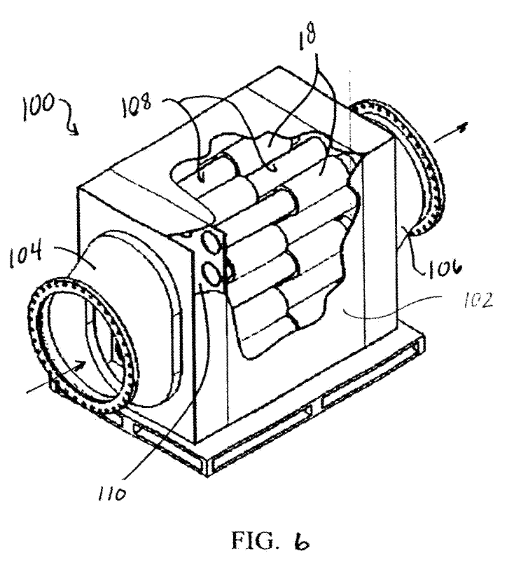

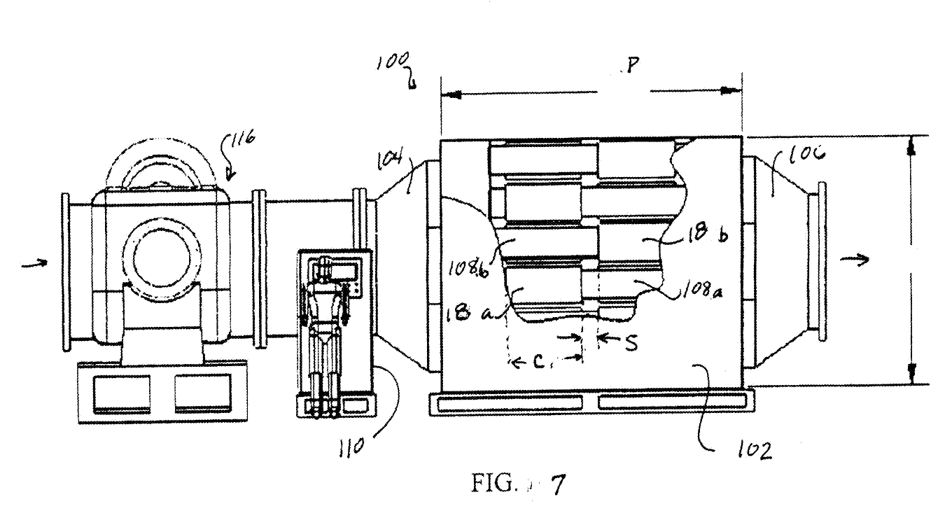

The method and apparatus disclosed herein provide for treating a large scale fluid flow with electromagnetic flux for the purpose of conditioning the liquid to reduce or eliminate the tendency of the fluid to deposit scale onto the surfaces of pipes, equipment, appliances and other apparatus to which it subsequently becomes exposed, to reduce or eliminate microorganisms which may be included in the liquid and/or for other purposes. A flow divider apparatus that incorporates a plurality of coil assemblies to provide the electromagnetic flux is shown in FIG. 6 and, together with a control unit 114 and an optional pump, in FIG. 7. The flow divider apparatus 100 comprises an enclosure 102 having an inflow coupler 104 and an outflow coupler 106 through which a large scale flow can pass, for example, 300,000 gallons per minute. The flow divider apparatus 100 contains a plurality of conduits indicated collectively by the numeral 108 each having an inlet end and an outlet end. Each inlet end is open to, and in fluid communication with, the inflow coupler 104 through a tube sheet 110, and each conduit 108 can receive a portion of the flow from the inflow coupler. There may be, for example, twenty-five conduits 108 to divide the large scale input flow from the inflow coupler 102. Thus, the inflow coupler 104 and the conduits 108 divide an input flow into a plurality of divided flows.

The outlet end of each conduit 108 is similarly open to, and in fluid communication with, the outflow coupler 106. Outflow coupler 106 coalesces the divided flows from the various conduits 108 and provides a single, large scale output flow.

The conduits 108 are disposed in close, parallel relation to each other, and are all substantially the same length. However, the invention is not limited in this regard, and in other embodiments, the conduits 108 may be in any other desired orientation relative to one another. Each conduit 108 is equipped with a coil assembly indicated collectively by the numeral 18 for exposing the flow in the associated conduit to ringing pulses as described herein.

To prevent the electromagnetic field generated by one coil assembly 18 on a conduit 108 from interfering with the electromagnetic field of a coil assembly on an adjacent conduit, or to at least reduce such interference, the coil assemblies are disposed on the conduits in staggered relation to each other between the inflow coupler 104 and/or to the outflow coupler 106. Accordingly, one coil assembly 18 is closer to the inflow coupler 104 than to the outflow coupler 106, while a coil assembly on an adjacent conduit 108 is closer to the outflow coupler 106 than to the inflow coupler 104.

As shown in FIGS. 6 and 7, the conduits 108 and the coil assemblies 18 are sized lengthwise such that staggered coil assemblies 18 are not coextensive with each other between the inflow coupler 104 and/or to the outflow coupler 106. To achieve this, adjacent conduits 108 are at least as long as the combined lengths of the coil assemblies 18 thereon. For example, as seen in FIG. 7, a first conduit 108a is coextensive with an adjacent second conduit 108b between the inflow coupler 104 and the outflow coupler 106, and the conduits both have a conduit length P of, for example, 4 meters. A first coil assembly 18a is on the inlet-end portion of the first conduit 108a, and has a coil assembly length C of 1.5 meters. A second coil assembly 18b of coil assembly length C is on the outlet-end portion of the first conduit 108a, and is thus in staggered relation to the first coil assembly 18a. The conduit length P of the conduits 108a and 108b (4 meters) exceeds the combined coil assembly lengths of the coil assemblies 18a and 18b thereon (3 meters) because each coil assembly length C is less than one-half of the conduit length P. However, the invention is not limited in this regard, and in other embodiments, one or more coil assemblies may have a coil assembly length that is one-half of the conduit length, or more than one-half the conduit length.

As also shown in FIGS. 6 and 7, no portion of the first coil assembly 18a is coextensive with the second coil assembly 18b between the inflow coupler 104 and the outflow coupler 106. In fact, there is a longitudinal space S separating the end of the first coil assembly 18a from the end of the second coil assembly 18b. However, the invention is not limited in this regard, and in other embodiments, staggered adjacent coils may have no longitudinal space between them, or they may be partially coextensive with each other. In still other embodiments, adjacent coil assemblies are not staggered relative to each other; rather, adjacent coil assemblies may be substantially coextensive with each other.

As shown in FIG. 7, the flow divider apparatus 100 may be used in conjunction with a pump 116 to maintain a desired flow rate through the flow divider apparatus 100.

Any suitable circuitry or mechanism may be provided to generate ringing pulses in the coil assemblies 18. For example, an input alternating current may be provided to a coil assembly 18 to generate low-frequency electromagnetic fields, and during selected half-cycles of the input alternating current, a power source may be connected to a coil assembly and then disconnected to generate one or more ringing pulses of higher frequency in the coil assembly.

As also seen in FIG. 7, a control unit 114 is provided to provide power and circuitry to generate ringing pulses in each coil assembly 18 as the fluid flows therethrough. The control unit 114 houses the power and control components (which may include transformer(s), fuses, status indicators, printed circuit board(s), connectors, terminal block(s), and ventilation ports/fans) that transmit the signals to the various coil assemblies. The control unit 114 display may also indicate the operating status and process characteristics of the system.

In use, a fluid is passed into the inflow coupler 104 and is then divided into a plurality of flows in the conduits 108. While flowing through the conduits 108, the control unit 114 provides power and circuitry as described above to generate low frequency electromagnetic fields and ringing pulses in the coil assemblies 18. The fluid then passes out the outlet ends of the conduits 108 and is combined into a single flow by the outflow coupler 106.

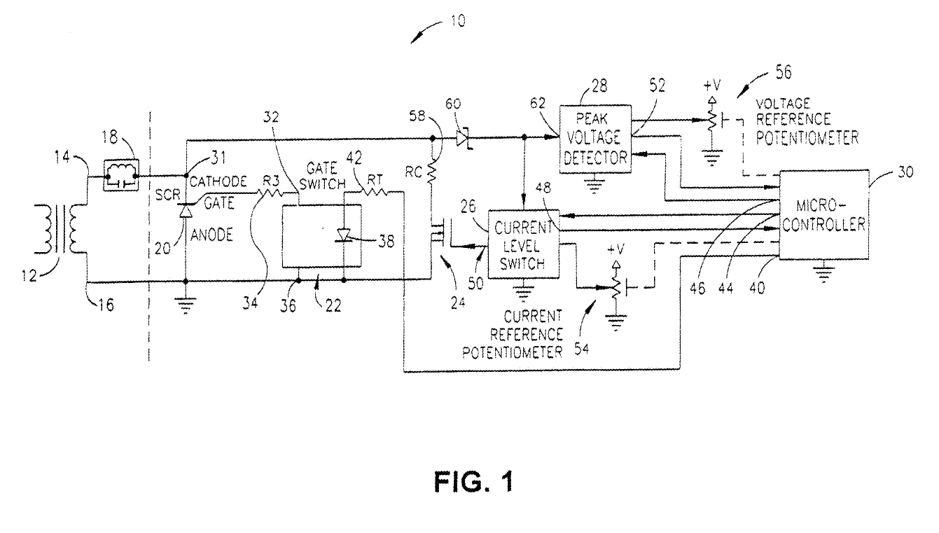

With reference to FIG. 1, an apparatus for generating a ringing magnetic pulse for treating flowing liquids in a coil assembly of a flow divider apparatus accordance with the present invention is indicated generally by the reference number 10. The apparatus 10 comprises an input power transformer 12 having first and second output terminals 14, 16, a coil assembly 18, an SCR 20, an optical relay 22, a MOSFET 24 serving as an electronically controlled switch, a current level switch 26, a peak voltage detector 28, and a programmable digital microcontroller 30.

The apparatus 10 utilizes a single silicon controlled rectifier switch (SCR 20) where prior art devices employed a MOSFET switch assembly. This substitution provides significant benefits in the generation of the ringing pulse as well as the low frequency electromagnetic field, both of which are considered important in the treatment of fluids. SCRs are available with higher current ratings and lower losses relative to MOSFETs, and a single device can easily handle the coil current. As a result of using the SCR where prior art devices employed a MOSFET, the ringing pulse and the low frequency electromagnetic field are generated more efficiently than in previous devices. However, SCRs cannot be electronically turned off as a MOSFET can, so that the high voltage “ringing” pulse has to be produced some other way than by interrupting the coil current pulse, as will be explained more fully below.

The coil assembly 18, which comprises a coil and is characterized as having an inductance and a capacitance connected in parallel, has a first end coupled to the first output terminal 14 of the transformer 12. The illustrated capacitance can be and is herein taken to be comprised solely of the capacitance of the coil, but in some coils the stray capacitance may be supplemented by a discrete capacitor connected in parallel with the coil. The SCR 20 has a cathode coupled to a second end 31 of the coil assembly 18, and an anode coupled to the second output terminal 16 of the transformer 12. As shown, the anode of the SCR 20 is coupled to electrical ground. The optical relay 22 serves as an SCR gate switch. As shown in FIG. 1, the optical relay 22 has a first terminal 32 coupled to the gate of the SCR 20 via a gate resistor 34, and a second terminal 36 coupled to ground potential. The optical relay 22 includes a light emitting diode (LED) 38 that when energized to emit light closes the gate switch to enable current flow between the first and second terminals 32, 36 of the optical relay 22. Thus, the coil assembly 18 and the SCR 20 form a series connected circuit in parallel to the power transformer 12, making a first loop. In one embodiment, the optical relay 22 may comprise a triac; in another embodiment, the optical relay may comprise a MOSFET.

The microcontroller 30 includes a first output 40 coupled to an anode of the LED 38 via a resistor 42, a second output 44 coupled to the current level switch 26, and a third output 46 coupled to the peak voltage detector 28. The current level switch 26 includes a first output 48 coupled to the microcontroller 30, and a second output 50 coupled to the gate of the MOSFET 24. The peak voltage detector 28 includes an output 52 coupled to the microcontroller 30. A digitally controlled current reference potentiometer 54 is coupled to an input of the current level switch 26, and is adjustable by the microcontroller 30. A digitally controlled voltage reference potentiometer 56 is coupled to the peak voltage detector 28, and is adjustable by the microcontroller 30.

The MOSFET 24, such as the illustrated n-channel IGFET with substrate tied to source, includes a source coupled to ground potential, and a drain coupled to the second end 31 of the coil assembly 18 via a current sense resistor 58. A high voltage Schottky diode 60 has an anode coupled to the second end 31 of the coil assembly 18 and a cathode coupled to an input 62 of the peak voltage detector 28.

The apparatus 10 is generally preferably mounted on a printed circuit board (not shown). However, two components are preferably external to the printed circuit board (PCB), namely, the coil assembly 18 and the power transformer 12. The transformer 12 provides a 50-60 Hz AC power to power the coil assembly 18. The main power component on the PCB is the SCR 20 which is preferably heat-sinked and which functions as a controllable diode. When an ordinary diode is forward-biased (anode voltage positive with respect to the cathode) it conducts current. When an SCR is forward-biased it will not conduct current unless the gate (control) lead is also forward-biased. Both an SCR and an ordinary diode will block current if they are reverse-biased.

When the gate lead of the SCR 20 is connected to the SCR anode (via a resistor), the SCR will conduct current when the SCR anode is positive with respect to The SCR cathode. This occurs during the negative voltage half-cycle (as referenced to the SCR anode which is considered to be circuit ground in FIG. 1). Since the coil assembly 18 is predominantly inductive (with some small internal resistance) at 60 Hz, negative current will continue to flow for a large portion of the positive voltage half-cycle. When the current drops to zero, the SCR 20 will block positive current flow (from cathode to anode) as does a diode rectifier. When the SCR 20 turns off, the voltage across the SCR will jump to a positive level during the remainder of the positive voltage half-cycle. It is during this positive voltage period that the microcontroller 30 generates at least one ringing current and voltage pulse within the coil assembly 18.

A ringing pulse across the coil assembly 18 is created by first closing the solid-state switch MOSFET 24 for a brief period at any time during the positive voltage cycle when the SCR 20 is off. The MOSFET 24 is closed, or made to conduct, by applying a positive voltage to its control electrode or gate via the current level switch 26. Positive current will build up in the coil assembly 18 while the MOSFET 24 is closed (the rise time is determined by the value of the current sense resistor 58 and the inductance of the coil assembly 18). When the current level reaches a designated trigger value, the MOSFET switch 24 is abruptly opened by the current level switch 26 (the current level switch removes the positive voltage from the gate of the MOSFET 24, which causes the MOSFET to become non-conducting). The inductance and capacitance values of the coil assembly 18 will determine the frequency of the resulting resonating current flow within the coil and the magnitude of the ringing voltage as viewed across the SCR 20. The decay time of the ring is determined by the internal resistance of the coil assembly 18.

The gate resistor 34 of the SCR 20 must be disconnected from the anode of the SCR during the positive voltage period to prevent the SCR from turning on when ringing pulses are generated—which would quickly terminate the ring. An optical relay 22 (as shown in FIG. 1) is provided for this purpose. The optical relay 22 need only be energized prior to the start of the negative voltage half-cycle. Once current starts to flow in the SCR 20, the optical relay 22 can be de-energized. The SCR 20 will continue to conduct until current drops to zero and the cathode-to-anode voltage across the SCR is positive. Interestingly, a small ringing pulse in the coil assembly 18 occurs when the SCR 20 switches off which is caused by the charge stored in the coil capacitance.

The operation of the apparatus 10 is primarily implemented using the programmable digital microcontroller 30 coupled to and aided by the peak voltage detector 28 and the current level switch 26. The microcontroller 30 does not directly interface with the coil assembly 18, the SCR 20 and the MOSFET 24; nor does the microcontroller directly view the coil voltage level. The coil voltage is presented to the current level switch 26 and the peak voltage detector 28 through the high voltage Schottky diode 60. The current level switch 26 and the peak voltage detector 28 compare the incoming voltage level to a reference voltage level set by the digitally controlled potentiometers 54, 56, respectively to determine its action.

The primary function of the peak voltage detector 28 is to compare the level of the coil ringing voltage signal to the reference level set by the digital potentiometer 56 associated with the peak voltage detector. If the peak level exceeds the given reference level, the peak voltage detector 28 will store that event so that it can be later read by the microcontroller 30. The stored event is cleared after it is read by the microcontroller 30. The peak voltage detector 28 is used to determine that the peak voltage exceeds the minimum desired value and also that it does not exceed a maximum value. A secondary function of the peak voltage detector 28 is to determine the value of the transformer voltage on start-up. The microcontroller 30 needs to know the transformer voltage because the ring signal rides on top of the transformer voltage. The transformer voltage reading is added to the desired ring voltage level when the reference voltage is set.

The current level switch 26 controls the MOSFET 24 used to generate the coil ringing pulse. The microcontroller 30 sends a trigger pulse to the current level switch 26 to initiate a ring. When triggered, the current level switch 26 raises the voltage on the gate lead of the MOSFET 24, thereby turning it on. The “on” resistance of the MOSFET 24 is much less than the value of the current sense resistor 58. The MOSFET 24 is held “on” until the voltage at the current sense resistor 58—coil junction (the cathode of the SCR 20) exceeds the reference voltage set by the current reference potentiometer 54 associated with the current level switch 26. The value of the resistor 58 and the reference voltage is not as important as ensuring that the current value at which the MOSFET 24 turns off is repeatable for a given potentiometer setting. The role of the microcontroller 30 is to adjust the current reference potentiometer 54 of the current level switch 26 to achieve the desired voltage level for the coil “ring.” Thus, the microcontroller 30, current reference potentiometer 54 and current level switch 26 regulate at least the initial voltage of the ringing current pulse. Optionally, the microcontroller 30, the current reference potentiometer 54 and current level switch 26 are adapted to keep the voltage of the ringing current plus between a predetermined minimum value and a predetermined maximum value.

The overall operation of the microcontroller 30 is executed in software embedded within the microcontroller. The functions of that software program are now described. When the apparatus 10 is first powered-up, the SCR 20 and the MOSFET 24 are both off (i.e. no current flows through the coil assembly 18). The first task of the microcontroller 30 is to test for the presence of coil power voltage from the transformer 12. This can be accomplished by setting the peak voltage detector 28 at a low level and monitoring the output. An alternative method is to monitor a tap provided in the current level switch 26 which reads zero when the coil voltage is negative and rises to +0.5V when the coil voltage goes positive. The microcontroller 30 waits until it observes two alternating 50-60 Hz power line voltage cycles before proceeding. When the AC coil voltage is detected, the microcontroller 30 will measure its peak level by monitoring the output of the peak voltage detector 28 while it raises the level of the voltage reference potentiometer 56. The peak level reading is retained in the microcontroller 30 and used as an offset for adjusting the level of the generated ring pulses which ride on the coil power voltage.

The next software task is to turn on the SCR 20, which is a periodic task occurring once per voltage cycle. Since the SCR anode is used as the ground-reference, the SCR anode-to-cathode voltage is negative during the positive voltage portion of the cycle. Just before the end of the positive voltage period, the SCR gate switch or optical relay 22 is turned on by powering its optically coupled LED 38. When the negative voltage across the SCR 20 is approximately 2 volts, the SCR will begin to conduct current, at which time power to the gate switch LED 38 is removed. The SCR 20 will remain latched on without the gate switch 22 being powered, until the SCR 20 current flow drops to zero.

The ringing pulses are produced by a second periodic software task. This task waits until the SCR 20 turns off and a positive coil voltage is detected (which is a sharp jump nearly the height of the peak coil voltage). The task waits a few milliseconds to allow the small coil ring (which occurs when the SCR 20 turns off) to die out. To generate a high voltage ringing pulse the software sends a trigger signal to the current level switch 26, which turns on the MOSFET 24, allowing positive current flow to rise in the coil assembly 18. The task monitors the current level switch 26. When the current level switch signals that the desired amount of current is present in the circuit, the MOSFET is turned off. The rapid cessation of the flow of current in the coil triggers a large coil ring.

The microcontroller generates a sequence of large ringing pulses in the second half-cycle of the AC power source. The timing of each ringing pulse in a sequence may be timed in relation to the preceding pulse. For example, the microcontroller may delay the generation of a subsequent ringing pulse for an idle period until the preceding ringing pulse substantially decays. For one example of such substantial decay, the generation of a subsequent ringing pulse may be delayed at least until the magnitude of a preceding pulse decays to about 5% of the initial magnitude. Following this idle period, the periodic software task is repeated and a second or subsequent large ringing pulse is generated. The number of pulses which may be generated during each positive voltage period depends on the inductance, capacitance, resistance, and voltage in the circuit; 4-6 rings are typical.

In an alternative embodiment, the microcontroller is programmed so that the wait time from when the MOSFET 24 is turned off to when the MOSFET 24 is turned on again in preparation for generating the next ring is shorter than in the preceding embodiment of the invention. As a result of this shorter wait period, the generation of significantly greater number of rings is possible during each positive voltage period, however, each ring is not permitted to substantially decay as it was in the first embodiment. For example, a subsequent ringing pulse may be generated before the preceding ringing pulse decays to about 5%, or to about 10%, of its initial magnitude. Optionally, a subsequent ringing pulse may be generated before the previous ringing pulse decays to about 25%, optionally before the previous ringing pulse decays to about 50% of its initial magnitude. In some embodiments, a subsequent ringing pulse may be generated when the magnitude of the preceding pulse decays to about 10 to about 50% of the initial magnitude. Optionally, a subsequent pulse may be generated when the magnitude of the preceding pulse decays by about 15 to about 25% of the initial magnitude.

During the negative voltage period, the microcontroller 30 determines if the peak voltage detector 28 has been triggered, which indicates that ringing signal exceeded the reference level set in the voltage reference potentiometer 56. The voltage reference potentiometer 56 can be set to either the minimum or the maximum desired peak voltage level. If the voltage reference potentiometer 56 is set for the minimum peak voltage, and the peak voltage detector 28 has not been triggered, the microcontroller 30 will increase the level of the current reference potentiometer 54 and leave the voltage reference potentiometer 56 at the minimum level. If the voltage reference potentiometer 56 is set for the minimum peak voltage, and the peak voltage detector 28 has been triggered, the microcontroller 30 will hold the level of the current reference potentiometer 54 and change the voltage reference potentiometer 56 to the maximum level. If the voltage reference potentiometer 56 is set to the maximum level, and the peak voltage detector 28 has been triggered, the microcontroller 30 will decrease the level of the current reference potentiometer 54 and leave the voltage reference potentiometer 56 at the maximum level. If the voltage reference potentiometer 56 is set to the maximum level, and the peak voltage detector 28 has not been triggered, the microcontroller 30 will hold the level of the current reference potentiometer 54 and change the voltage reference potentiometer 56 to the minimum level. The preceding actions will move and hold the peak voltage level for the ring pulse between the minimum and maximum desired values. The above logic pattern serves as a digital voltage regulator for the ringing voltage pulse.

Also during the negative voltage period, the microcontroller 30 reads the resistance value of a negative temperature coefficient (NTC) thermistor (not shown) affixed to the heat sink of the SCR 20. If the resistance drops below the value equated to the maximum temperature designated for the SCR heat sink (which is lower than destruction level for the SCR 20) the microcontroller 30 will turn off the SCR and also cease generating ringing pulses. The microcontroller 30 will continue to periodically read the thermistor and when it is determined that the SCR temperature has dropped to a safe level, the microcontroller will automatically resume operation.

On the bottom of the printed circuit board can be two status LEDs (not shown)—preferably one red and one green—viewable through holes in a controller cover. The green LED is lit when the microcontroller 30 has determined that the voltage level of the ringing pulses is within the desired range, otherwise the red LED is lit. A single-pole double-throw relay contact (not shown) is preferably provided for remotely monitoring the status—when the green LED is lit the relay is energized.

The functioning of the above-described SCR-switched circuit is as follows: The SCR (Silicon Controlled Rectifier) acts like a diode with a controllable turn-on capability. When voltage is applied in the “forward direction” (forward-biased-anode positive with respect to cathode) a diode will conduct current. However, the SCR will NOT conduct when forward-biased unless a current is made to flow in its “gate” circuit. If no gate current is applied, the SCR will “block” the flow of current even when forward-biased. Both the SCR and the diode will block the flow of current when the direction of current flow reverses (cathode to anode is the reverse-current direction). The SCR cannot be turned off by removing its gate current after it has been turned on. It can only be turned off by reversing the direction of current flow. In this it acts the same as a silicon diode (rectifier). Hence its name, “silicon controlled rectifier”.

With this as background, a normal cycle of the system proceeds as follows. The coil, transformer and SCR switch are all connected in series. When the time-varying (50 or 60 cycles per second) transformer voltage applies a forward bias to the SCR, gate current is applied and the SCR conducts current through the coil. The SCR has a very low voltage drop from anode to cathode when conducting (less than or equal to one volt typically) so it acts like an almost-perfect switch. On the circuit boards of prior devices MOSFETs (Metal-Oxide-Silicon Field Effect Transistors) are used as the switch, and these MOSFETs have a larger “forward” voltage drop than does an SCR and so dissipate more heat than the SCR. For this reason, in the prior devices ten parallel-connected MOSFETs are used to carry the coil current, where a single SCR will do the same job in devices according to the present invention with lower overall power loss.

When the coil current attempts to reverse direction, the SCR turns off and allows voltage to rise across it, just as a diode would do. The SCR then blocks current flow when the current reverses. Because the voltage and current across the coil are almost 90 degrees out of phase with each other, the current crosses zero (reverses) when there is still substantial voltage across the coil. This frees the coil to “ring” at a low voltage level due to the energy stored in its stray capacitance.

After this initial small or natural “ringing” pulse has died out, a small current is allowed to build up in the coil by closing a MOSFET switch. This switch does not carry the main coil current, so a small switch can be used for this “recharging” function.

When this current has reached a preset level, the MOSFET is turned off, and the coil voltage “rings” again, this time producing a large ringing pulse at a higher voltage level, depending on the amount of current that is allowed to build up.

The regulator circuit measures the peak value of this “ringing” voltage and compares it to the desired value, which is stored as a number in the microprocessor “chip” on the circuit board. If the voltage is too low, then after the ringing pulse has died away the microprocessor turns the MOSFET on again and holds it “on” for a longer time, allowing more coil current to build up than before. The MOSFET is then turned off, and the large ringing pulse repeats.

If the pulse voltage is too high, the microprocessor reduces the “on time” of the MOSFET switch for the next pulse, causing less coil current to build up. The MOSFET then turns off and the ringing voltage is again measured.

When the ringing voltage has reached the desired level (it falls within a “window” range of voltages stored in the microprocessor), the regulator “remembers” this and fixes the MOSFET “on” time for subsequent pulses at this value unless the pulse voltage drifts outside the “window” again. This can occur if the coil resistance changes as the coil temperature changes during operation. If that occurs, preceding steps are repeated until the voltage is once again within the “window”.

All the large “ringing” pulses are generated during the interval when the SCR switch is reverse-biased by the applied circuit voltage from the power transformer. The SCR allows the ringing pulses to occur (its gate current is zero during this interval), even though the ringing pulse voltage will at times cause the SCR voltage to switch over to the “forward” bias condition. The SCR will not turn on when this occurs, unlike a diode, as its gate current is held to zero by the gate driver switch.

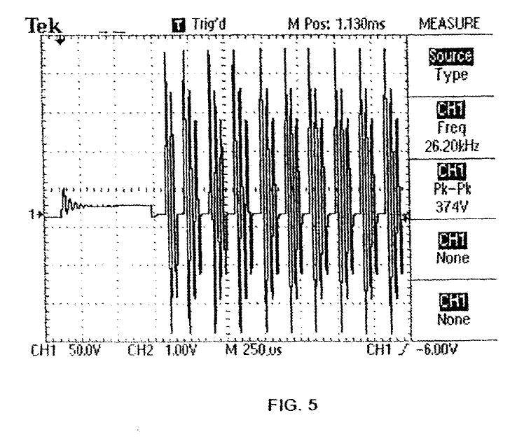

Several large ringing pulses can be inserted in the reverse bias time interval. The number of pulses depends on the desired voltage of the pulse, the inductance of the coil, the capacitance in parallel with the coil (including stray capacitance) and the degree to which each pulse is permitted to decay. In a first embodiment of the invention, each pulse is allowed to substantially (optionally, fully) decay and, all other parameters being equal, fewer pulses are produced. In a second embodiment of the invention, the pulses are not permitted to substantially decay prior to the generation of the next pulse; this allows the generation of a significantly greater number of pulses. The difference between these embodiments may be seen by comparing FIGS. 4 and 5.

Other techniques can be used to generate ringing pulses similar to those described above. The preferred technique, as described above, uses the coil's inductance as an energy storage element to generate the ringing voltage, so it is a simpler method than others which must store the energy elsewhere. However, any device that stores the required pulse energy can be used to generate a ringing pulse. For example, a capacitor can be charged to 150 volts (or any other desired voltage) and switched across the coil during the “off time” of the coil current. This too will generate a ringing pulse, but it requires a high voltage power supply and an extra capacitor. This method also increases the capacitance in the “ringing” circuit, and causes a lower “ringing” frequency than our method does. The preferred method uses the unavoidable “stray” capacitance of the coil as the resonating capacitance, and generates the highest possible ringing frequency.

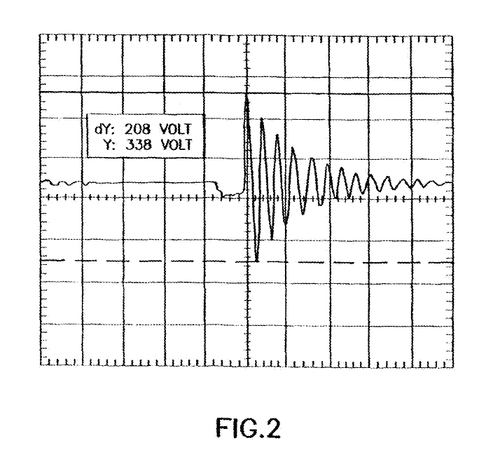

A session testing the performance of a device such as shown by FIG. 1 and as described above with a digital scope on a workbench produced the results shown in FIGS. 2, 3 and 4. As can be seen, the inventive control circuit can fit several (in this case six) large ringing pulses into the available “off” time window between transformer current pulses. The number of large ringing pulses is selectable by inputting a number to the control program via the computer programming interface.

FIG. 2 shows a single pulse from the group; the printing at the left indicates the two horizontal cursor lines were 208 volts apart. The sweep speed is 100 microseconds (μs)/division. The voltage scale is 50V/division.

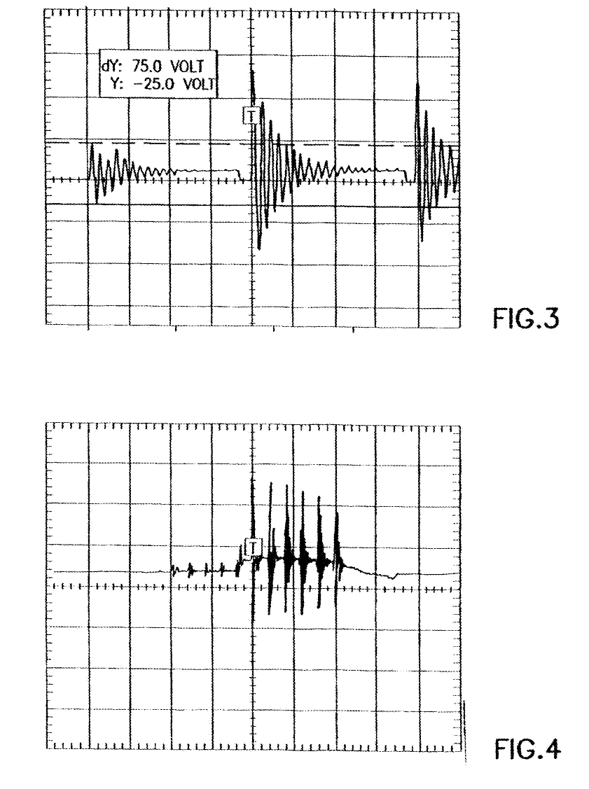

In FIG. 3 is seen the first “natural” ring when the SCR turns off, about 75 volts peak-to-peak. Then come the large rings caused by the control circuit. The large ringing pulses are between three and four times larger in voltage than the small “natural” ringing pulse. More than one large ringing pulse visible in FIG. 3. The sweep speed for this FIG. 3 is 200 μs/division and the voltage scale is 50V/division.

In FIG. 4 we see a full six large ringing pulses. These fit into the approximately 8 millisecond “SCR off” time for this size (one inch) device. With larger coils, this time may be shorter and fewer pulses will fit in. The sweep speed here is 2 ms/division and the voltage scale is 50V/division.

Finally, FIG. 5 shows the result of more than six ringing pulses in an embodiment in which new ringing pulses are initiated before prior pulses decay.

As is evident from the foregoing description, one or more large ringing pulses is generated within a time interval defined as a portion of a single cycle of a 50 or 60 Hz AC signal. Thus, each such time interval has a duration corresponding to a portion of a cycle of a 50 or 60 Hz signal. Optionally, the one or more large ringing pulses are generated in successive intervals defined as portions of successive cycles of the 50 or 60 Hz AC signal, in which case the one or more large ringing pulses are said to occur in successive intervals spaced at 50 or 60 Hz.

In summary, the apparatus and method embodying the present invention employs an SCR for handling the main coil current which is responsible for the formation of the low frequency electromagnetic field, and uses a single MOSFET switch to draw a relatively small current through the current coil(s) after the main current pulse has ended. One or more large ringing pulse or pulses is then produced by turning this switch off. Several ringing pulses can be produced in this way during the zero current interval through the coils. The number of pulses which may be generated depends on the characteristics of the system and whether each ring is allowed to substantially decay (first embodiment) or whether subsequent rings are generated prior to substantial decay in the previous ring (second embodiment).

Due to the complexity of the process for producing the ringing pulses, the majority of this specification is devoted to the method and circuit associated with the generation of the ringing pulse. It should not be construed, however, that the process and equipment associated with the ringing pulse is of any greater importance than the process and equipment associated with the low frequency electromagnetic field.

One way to practice this invention is to situate a fluid flow in proximity to the coil assembly while ringing pulses are being generated, for example, by flowing the fluid through the magnetic flux generated by the coil assembly during the ringing pulses. In a particular embodiment, an apparatus embodying the invention may comprise a conduit 108 that includes a pipe through which liquid to be treated passes. The pipe may be made of various materials, but as the treatment of the liquid effected by the pipe unit involves the passage of electromagnetic flux through the walls of the pipe and into the liquid passing through the pipe, the pipe is preferably made of a non-electrical conducting material to avoid diminution of the amount of flux reaching the fluid therein.

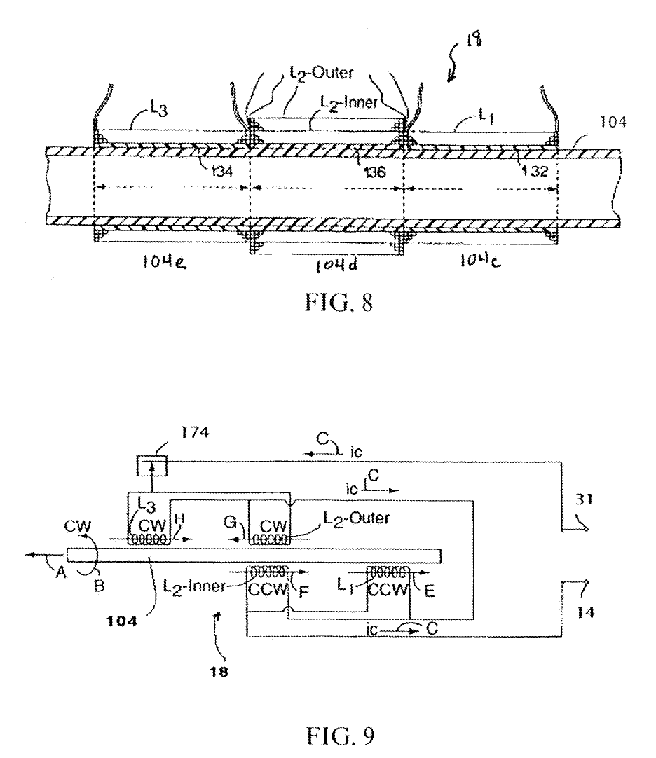

A coil assembly 18 may comprise a number of component coils. One illustrative embodiment of a coil assembly 18 on a conduit 108 is shown in FIG. 8, which shows a coil assembly that consists of four coils, L₁, L₂-outer, L₂-inner and L₃ arranged in a fashion similar to that of U.S. Pat. No. 6,063,267, which is incorporated herein by reference. Briefly restated, the coils L₁, L₂-outer, L₂-inner and L₃ are associated with three different longitudinal sections 104c, 104d, and 104e of the conduit 108, which is a pipe. That is, the coil L₁ is wound onto and along a bobbin 132 in turn extending along the pipe section 104c, the coil L₃ is wound on and along a bobbin 134 itself extending along the pipe section 104e, and the two coils L₂-inner and L₂-outer are wound on a bobbin 136 itself extending along the pipe section 104d, with the coil L₂-outer being wound on top of the coil L₂-inner. The winding of the two coils L₂-inner and L₂-outer on top of one another, or otherwise in close association with one another, produces a winding capacitance between those two coils which forms all or part of the capacitance of a series resonant circuit as hereinafter described.

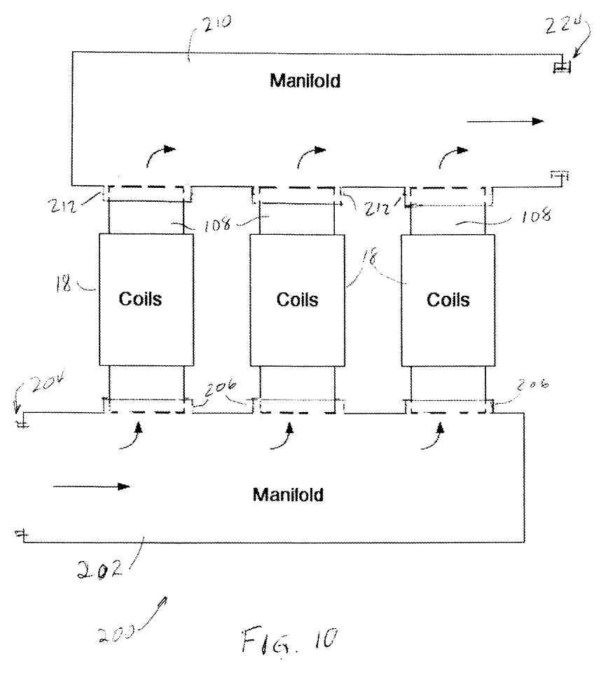

A wiring diagram for the coil assembly 18 of FIG. 8 is shown in FIG. 9. The input terminals of the coil assembly 18 connect to the input power transformer 12 and to the SCR 20 as shown in FIG. 1. This particular embodiment of coil assembly 18 includes a thermal overload switch 174. The arrow B indicates the clockwise direction of coil winding, and in keeping with this reference the coil L3 and the coil L2-outer are wound around the conduit 108 in the clockwise direction and the coils L1 and L2-inner are wound around the pipe in the counterclockwise direction. However, the invention is not limited to a specific coil configuration.

Representative flow capacities of pipes that are treatable with ringing pulses from a coil assembly 18 as shown in FIG. 8 are shown in the following table. Such data is used to guide the design of the flow divider apparatus 100 with regard to the number and size of the conduits between the inflow coupler 104 and the outflow coupler 106 relative to the scale of the flow into the flow divider apparatus.

| | | | | | Typical Treatable |
|---|---|---|---|---|---|
| | | | | Nominal | Flow Capacity |
| | | Coils | | Power | cubic meters per |
| | | L2 Inner | | Supply | minute (m³/min) |
| Nominal | | L2 Outer | | Voltage | (gallons per |
| Pipe Size | Coil L1 | (each) | Coil L3 | (Loaded) | minute (gpm)) |
| 25 cm | Turns 120 | Turns 120 | Turns 120 | 39 V (rms) | 10.2 m³/min |
| (10 inch) | Wire 9 Ga | Wire 9 Ga | Wire 9 Ga | | (2700 gpm) |
| | Length 6.75″ | Length 6.75″ | Length 6.75″ | | |
| 30.5 cm | Turns 120 | Turns 120 | Turns 120 | 39 V (rms) | 14.3 m³/min |
| (12 inch) | Wire 9 Ga | Wire 9 Ga | Wire 9 Ga | | (3800 gpm) |
| | Length 6.75″ | Length 6.75″ | Length 6.75″ | | |
| 40.6 | Turns 95 | Turns 120 | Turns 96 | 39 V (rms) | 22.7 m³/min |
| (16 inch) | Wire 8 Ga | Wire 8 Ga | Wire 8 Ga | | (6000 gpm) |
| | Length 5.5″ | Length 5.5″ | Length 5.5″ | | |

Optionally, the conduits 108 in a fluid treatment flow divider apparatus may be connected to one or more manifolds. For example, a fluid treatment flow divider apparatus generally designated by the numeral 200 in FIG. 10 comprises intake manifold 202. The intake manifold 202 includes an inflow coupler 204 that is adapted to receive a large scale flow of untreated fluid. The intake manifold 202 provides fluid communication with a plurality of manifold outlets 206. Each manifold outlet 206 is coupled to a conduit 108. Each conduit 108 is equipped with a coil assembly 18 to treat the flow therein as described above. There is an outlet manifold 210 which comprises a plurality of manifold inlets 212 in fluid communication with an outflow coupler 224. Each manifold inlet 212 is coupled to a respective conduit 108 for fluid communication therewith. The outlet manifold 210 is thus adapted to receive flows of treated fluid from the conduits 108 and to coalesce the flows into a large scale output flow, which is discharged via the outflow coupler 224.

The terms “first,” “second,” and the like, herein do not denote any order, quantity, or importance, but rather are used to distinguish one element from another. In addition, the terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

What is claimed is:

1. A method for subjecting an input flow of fluid to pulsed energy, comprising:
dividing the input flow into a plurality of divided flows;
subjecting each divided flow to pulses of electromagnetic energy; and
coalescing the plurality of divided flows into a single output flow.

2. The method of claim 1, comprising flowing the input flow into the inflow coupler of a flow divider apparatus that comprises the inflow coupler, a plurality of conduits each having an inlet end and an outlet end, with each inlet end being open to, and in fluid communication with, the inflow coupler, each conduit having a coil assembly thereon, and a outflow coupler open to, and in fluid communication with, the outlet end of each conduit; whereby the input flow is divided into a plurality of divided flows that pass simultaneously through the plurality of conduits; and comprising applying pulses of electrical energy to each coil assembly.

3. The method of claim 2, comprising subjecting divided flows in adjacent conduits to pulses of electromagnetic energy in staggered relation to each other relative to the input end and output end of each adjacent conduit.

4. The method of claim 1, comprising providing to each coil assembly an AC power source having a period including a first half-cycle of one polarity and a second half cycle of a polarity opposite to that of the first half-cycle; conducting current from the AC power source in first loop comprising the AC power source, the coil assembly and a first switch, during at least a portion of a first half-cycle of the AC power source period, and opening the first switch during a second half-cycle of the AC power source period; and during the second half-cycle of the AC power source period, performing a subroutine that comprises closing and opening a second switch, the second switch being in a second loop with the coil assembly, to produce a large ringing pulse in the coil assembly.

5. The method of claim 4, comprising producing, during the second half-cycle of the AC power source period, a plurality of large ringing pulses in the coil assembly.

6. The method of claim 5, wherein the plurality of large ringing pulses includes a second large ringing pulse that is initiated after a first large ringing pulse substantially decays.

7. The method of claim 5, wherein the plurality of large ringing pulses includes a second large ringing pulse that is initiated before a first large ringing pulse substantially decays.

8. The method of claim 5, wherein the plurality of large ringing pulses includes a second large ringing pulse that is initiated before a first large ringing pulse substantially decays by about 50% of its initial magnitude.

9. The method of claim 5, wherein after the first large ringing pulse, each subsequent ringing pulse is produced before the ringing pulse prior thereto substantially decays.

10. The method of claim 4, comprising producing a large ringing pulse in each of a plurality of second half-cycles of the AC power source period, wherein the AC power source has a period of 50 or 60 Hz.

11. The method of claim 4, comprising producing a plurality of large ringing pulses in each of a plurality of second half-cycles of the AC power source period, wherein the AC power source has a period of 50 or 60 Hz.

12. The method of claim 11, wherein the plurality of large ringing pulses includes a second large ringing pulse that is initiated after a first large ringing pulse substantially decays.

13. The method of claim 11, wherein the plurality of large ringing pulses includes a second large ringing pulse that is initiated before a first large ringing pulse substantially decays.

14. The method of claim 11, wherein the plurality of large ringing pulses includes a second large ringing pulse that is initiated before a first large ringing pulse substantially decays by about 50% of its initial magnitude.

15. The method of claim 11, wherein after the first large ringing pulse in the plurality of large ringing pulses, each subsequent ringing pulse is produced before the ringing pulse prior thereto substantially decays.

16. A fluid treatment flow divider apparatus comprising:
a inflow coupler;
a plurality of conduits each having an inlet end and an outlet end, with each inlet end being open to, and in fluid communication with, the inflow coupler, each conduit having a coil assembly thereon; and
a outflow coupler open to, and in fluid communication with, the outlet end of each conduit.

17. The apparatus of claim 16, wherein coil assemblies on adjacent conduits are staggered in relation to each other between the inflow coupler and the outflow coupler.

18. The apparatus of claim 16, wherein coil assemblies on adjacent conduits are staggered and not in coextensive relation with each other between the inflow coupler and the outflow coupler.

19. The apparatus of claim 16, further comprising a control circuit for each coil, for generating ringing pulses in the coil assembly.

20. The apparatus of claim 19, wherein coil assemblies on adjacent conduits are staggered from each other between the inflow coupler and the outflow coupler.

21. The apparatus of claim 19, wherein coil assemblies on adjacent conduits are staggered and not in coextensive relation with each other between the inflow coupler and the outflow coupler.

22. The apparatus of claim 16, comprising coil assemblies disposed substantially coextensively on adjacent conduits.

23. The apparatus of claim 16, comprising:
an AC power source connected with each coil assembly, the AC power source having a period including a first half-cycle of one polarity and a second half cycle of a polarity opposite to that of the first half-cycle;
a first switch connected in series with the coil assembly to form a series connected circuit;
a second switch connected with the coil assembly to form a second circuit; and
controller for the first switch, the controller being configured to close the first switch and open the second switch during a first half-cycle of the AC power source period and, during a second half-cycle, to perform a subroutine of closing and then opening the second switch to produce a first large ringing pulse in the coil assembly.

24. The apparatus of claim 23, wherein said first switch is a silicon controlled rectifier (SCR) forming a first electrical loop with the coil assembly and the AC power source.

25. The apparatus of claim 23, wherein the second switch is electrically connected in parallel with the SCR.

26. The apparatus of claim 23, wherein the second switch is a MOSFET.

27. The apparatus of claim 23, wherein the subroutine comprises providing plurality of large ringing pluses in the coil assembly during the second half-cycle of the AC power source period.

28. The apparatus of claim 27, wherein the plurality of large ringing pulses includes a second large ringing pulse that is initiated after a first large ringing pulse substantially decays.

29. The apparatus of claim 27, wherein the plurality of large ringing pulses includes a second large ringing pulse that is initiated before a first large ringing pulse substantially decays.

30. The apparatus of claim 27, wherein the plurality of large ringing pulses includes a second large ringing pulse that is initiated before a first large ringing pulse substantially decays by about 50% of its initial magnitude.

31. The apparatus of claim 27, wherein after the first large ringing pulse, each subsequent ringing pulse is produced before the ringing pulse prior thereto substantially decays.

32. The apparatus of claim 23, wherein the subroutine comprises producing a large ringing pulse in each of a plurality of second half-cycles of the AC power source period, wherein the AC power source has a period of 50 or 60 Hz.

33. The apparatus of claim 32, wherein the subroutine comprises producing a plurality of large ringing pulses in each of a plurality of second half-cycles of the AC power source period, wherein the AC power source has a period of 50 or 60 Hz.

34. The apparatus of claim 33, wherein the plurality of large ringing pulses includes a second large ringing pulse that is initiated after a first large ringing pulse substantially decays.

35. The method of claim 34, wherein the plurality of large ringing pulses includes a second large ringing pulse that is initiated before a first large ringing pulse substantially decays.

36. The apparatus of claim 33, wherein the plurality of large ringing pulses includes a second large ringing pulse that is initiated before a first large ringing pulse substantially decays by about 50% of its initial magnitude.

37. The method of claim 33, wherein after the first large ringing pulse, each subsequent ringing pulse is produced before the ringing pulse prior thereto substantially decays.
